(19) United States
(12) Patent Application Publication
(10) Pub. No.: US 2018/0084588 A1
(43) Pub. Date: Mar. 22, 2018

(54) Managing Automatic Connections to a Wireless Dock

(71) Applicant: Microsoft Technology Licensing, LLC, Redmond, WA (US)

(72) Inventors: Issa Yousef Khoury, Redmond, WA (US); Keri K. Moran, Redmond, WA (US); Kristina Rose Cosgrave, Kirkland, WA (US); Darren R. Davis, Woodinville, WA (US); Jennifer S. Yim, Bellevue, WA (US); Petteri Jussinpoika Mikkola, Bellevue, WA (US); Travis Joe Johnston, Redmond, WA (US); Anshul Pradip Kanakia, Kirkland, WA (US)

(73) Assignee: Microsoft Technology Licensing, LLC, Redmond, WA (US)

(21) Appl. No.: 15/268,415

(22) Filed: Sep. 16, 2016

(51) Int. Cl. H04W 76/02; H04W 4/02; H04W 4/00; H04M 1/725

(52) U.S. Cl. CPC H04W 76/02; H04W 4/023; H04M 1/72563; H04W 4/021; H04W 4/008

(57) ABSTRACT

Managing automatic connections to a wireless dock is described. A connection manager is configured to initiate a first user experience by causing display of a first user interface on a display device coupled to a wireless dock in response determining that the mobile computing device is within a close proximity to the wireless dock based at least in part on the first wireless radio detecting the beacon signal associated with the wireless dock. Then, in response to detecting a user action to interact with a peripheral device coupled to the wireless dock, the connection manager initiates a second user experience by causing display of a second user interface on the display device coupled to the wireless dock. The first or second user experience may also include forming a wireless connection with the wireless dock using a second wireless radio.

### BACKGROUND

A conventional mobile computing device, such as a smartphone, tablet, or laptop, may be configured to establish an automatic connection to a wireless dock each time that the mobile computing device is within a certain proximity to the wireless dock. However, configuring a device to automatically reconnect to a wireless dock may drain the device's battery because the device must constantly be woken up from standby to scan for the wireless dock. Furthermore, each time that the device comes within close proximity to the wireless dock, the device will establish a connection with the wireless dock even in situations where the user may not intend to connect to the wireless dock. This is especially problematic when the device is in a low power mode because the device's battery is rapidly drained from being unable to enter into a proper low-power state. Or, once in a low-power state, the device is never able to remain in that state for a significant period of time. Furthermore, if the device connects each time it is in proximity to the dock, and causes external screens to begin displaying content, this may be annoying to the user if the user does not want to connect to the dock at that time.

Some wireless radios configured to detect proximity, e.g., Bluetooth Low Energy (BTLE), have a limited number of hardware listener slots. BTLE hardware is programmed to operate in a very low power mode allowing it to listen for the presence of a particular beacon and then wake the system up. A particular beacon associated with a wireless dock is represented by programming the BTLE hardware to listen for a particular pattern. Each of these pattern registrations takes up a “slot” in the hardware. The exact number of slots available for hardware offload is a function of the hardware, but conventional BTLE hardware supports a maximum of just 20 slots, which means that an attempt to register more than 20 beacon listeners will result in a failure on the next item.

In an effort to limit the number of slots required, one conventional technique is to coalesce the different patterns into a broader, more general pattern. For example, assume three patterns are being searched for—ABCE, ABCDE, and ABCDEF. These three patterns may be coalesced into a single slot by listening simply for the ABC pattern. Once awakened, the system would need to evaluate the pattern to determine which full pattern actually woke the device. While this would reliably wake the system for these three patterns it would also wake the system for the patterns ABCF, ABCDEG, and ABCDEFG among many others. The frequency of these “false positives” could have a significant ramification on the overall battery life of the device because of the number of times the system is pulled out of sleep to service them.

The limited number of slots also impacts the user's ability to install and use multiple third party applications which try to leverage background listeners. Since the slots available to the operating system are also exposed to applications, making the available listener slots now become a shared resource between the operating system and applications. If the operating system or an application uses a significant number of slots then it is possible for the slots to become quickly exhausted, the apps to stop working, or the power savings to disappear entirely. For example, some current applications may consume as many as 10 listener slots for each instance of their platform which is installed. Thus, ifjust two instances of this application is installed, the number of available listener slots will be completely filled.

### SUMMARY

Managing automatic connections to a wireless dock is described. In various implementations, a mobile computing device includes a first wireless radio configured to listen for a beacon signal associated with a wireless dock, and a second wireless radio configured to form a wireless connection to the wireless dock. In some cases, the first wireless radio corresponds to a low bandwidth wireless radio (e.g., a Bluetooth Low Energy (BTLE) radio), whereas the second wireless radio corresponds to a high bandwidth wireless radio (e.g., a Wi-Fi radio). A connection manager is configured to initiate a first user experience by causing display of a first user interface on a display device coupled to the wireless dock in response determining that the mobile computing device is within a close proximity to the wireless dock based at least in part on the first wireless radio detecting the beacon signal associated with the wireless dock. Then, in response to detecting a user action to interact with a peripheral device (e.g., touch screen, mouse, keyboard) coupled to the wireless dock, the connection manager is configured to initiate a second user experience by causing display of a second user interface on the display device coupled to the wireless dock. In one or more implementations, the first user experience includes forming the wireless connection to the wireless dock using the second wireless radio, and using the wireless connection to initiate the first user experience. In other implementations, the first user experience is initiated without forming the wireless connection to the wireless dock. In this case, the first user experience is initiated by utilizing the first wireless radio to communicate a control signal or instructions to the wireless dock effective to cause the wireless dock to display the first user interface. Subsequently, in response to detecting the user action, the second user experience includes forming the wireless connection to the wireless dock using the second wireless radio.

In one or more implementations, the connection manager is configured to cause the first wireless radio to begin listening for the beacon signal associated with the wireless dock when the mobile computing device moves within a general proximity to the wireless dock, and to cause the first wireless radio to stop listening for the beacon signal associated with the wireless dock when the mobile computing devices moves outside the general proximity to the wireless dock.

### BRIEF DESCRIPTION OF THE DRAWINGS

The detailed description is described with reference to the accompanying figures. The same numbers are used throughout the drawings to reference like features and components.

FIG. 1 is an illustration of an environment in an example implementation that is operable to employ techniques for managing automatic connections to a wireless dock.

FIG. 2 illustrates an example of using a general proximity boundary and a close proximity boundary to manage automatic connections to a wireless dock.

FIG. 3 illustrates an example of initiating first and second user experiences in accordance with one or more implementations.

FIG. 4 illustrates a procedure in an example implementation of managing automatic connections to a wireless dock.

FIG. 5 illustrates an example system that includes an example computing device that is representative of one or more systems and/or devices that may implement the various techniques described herein.

### DETAILED DESCRIPTION

### Overview

Managing automatic connections to a wireless dock is described. In various implementations, a mobile computing device (e.g., a smartphone) includes a first wireless radio (e.g., a Bluetooth Low Energy (BTLE) radio) configured to listen for a beacon signal associated with a wireless dock and optionally provide minimum command, control and data, and a second wireless radio (e.g., a Wi-Fi radio) configured to form a wireless connection to the wireless dock for the purpose of running one or more protocols (e.g., Miracast) handling display and peripheral connections.

A connection manager is configured to initiate a first user experience by causing display of a first user interface (e.g., a welcome message) on a display device coupled to the wireless dock in response to determining that the mobile computing device is within a close proximity to the wireless dock. The first user experience provides a passive and non-intrusive experience for the user.

The connection manager may determine that the mobile computing device is within the close proximity to the wireless dock based at least in part on the first wireless radio detecting the beacon signal associated with the wireless dock. For example, a signal strength of the beacon signal may be used to determine an approximate distance of the mobile device from the wireless dock. Notably, it may not make sense to initiate the first user experience if the user is walking by the wireless dock without stopping. Thus, in some cases, the connection manager may use acceleration data, received from an accelerometer attached to the mobile computing device, to determine that the user is not moving (e.g., the user is sitting or standing by the wireless dock) which indicates that the user intends to use the wireless dock. Thus, the acceleration data can be used to prevent the mobile device from initiating the first user experience in situations where the user walks past the wireless dock without intending to connect to the wireless dock. Doing so conserves battery life of the mobile computing device because the first user experience may only be initiated in instances where there is a high likelihood that the user intends to use the wireless dock.

In one or more implementations, the first user experience includes forming the wireless connection to the wireless dock using the second wireless radio (e.g., Wi-Fi) and one or more protocols (e.g., Miracast), and using the wireless connection to initiate the first user experience (e.g., by communicating the welcome message to the wireless dock using the wireless connection). In other implementations, the first user experience is initiated without forming the second wireless connection to the wireless dock. In this case, the first user experience is initiated by using the first wireless radio (e.g., the BTLE radio) to communicate a control signal or instructions to the wireless dock effective to cause the wireless dock to display the first user interface. In this implementation, the battery life of the mobile computing device is conserved because the wireless connection is not automatically established each time that the mobile computing device comes within the close proximity to the wireless dock.

After the first user experience is initiated, the connection manager monitors for a user action indicative of user intent to use the wireless dock, such as the user interacting with a peripheral device (e.g., touch screen, mouse, keyboard) coupled to the wireless dock. In cases where the wireless connection is formed as part of the first user experience, the connection manager can detect the user action based on signals communicated from the wireless dock to the mobile computing device over the wireless connection using the second wireless radio. Alternately, in cases where the wireless connection is not formed as part of the first user experience, the connection manager can detect the user action based on signals communicated from the wireless dock using the first wireless radio (e.g., a BTLE signal).

Then, in response to detecting the user action, the connection manager initiates a second user experience by causing display of a second user interface on the display device coupled to the wireless dock. In cases where the wireless connection is not formed as part of the first user experience, initiating the second user experience also includes establishing the wireless connection with the wireless dock using the second wireless radio. Notably, the information displayed in the second user interface is different than the information displayed in first user interface. Thus, the system recognizes that the user action indicates that the user has sat down or intends to interact with the system, and thus a next level of information is displayed to the user. The second user interface, for example, may correspond to the start screen or lock screen which enables the user to begin interacting with the mobile computing device using the peripheral devices coupled to the wireless dock.

In one or more implementations, the connection manager is configured to cause the first wireless radio to begin listening for the beacon signal associated with the wireless dock when the mobile computing device moves within a general proximity to the wireless dock (e.g., within a “geo-fence”), and to cause the first wireless radio to stop listening for the beacon signal associated with the wireless dock when the mobile computing devices moves outside the general proximity to the wireless dock. For example, when the mobile device is within the general proximity, the connection manager can cause the BTLE radio to begin listening for the beacon signal associated with the wireless dock by registering the BTLE radio in a listener slot. Then, when the mobile device moves outside of the general proximity, the BTLE radio may be removed from the listener slot. This guarantees that only when there is a high likelihood of actually connecting to the wireless dock is the listener slot actively used.

As an example of the described techniques, consider that a user named John configures his smartphone to automatically establish a wireless connection to a wireless dock that is paired with a monitor in John's cubicle at work. Now, each time that John walks into his office building, the connection manager registers a BTLE listener slot on John's mobile phone to begin listening for a beacon signal transmitted from the wireless dock in John's cubicle. Waiting until John is in the office building to register the BTLE listener guarantees that the listener slot is only used when the connection manager is reasonably sure that the wireless dock is likely to be discovered. Furthermore, when John leaves the office building, the connection manager removes the BTLE listener from the listener slot, which frees up the listener slot for other applications or uses. For example, the connection manager may register a different BTLE listener to scan for a wireless dock in John's house once he walks in the front door of his house.

Once inside his office building, John walks towards his cubicle, and the BTLE listener detects that John is close to the wireless dock. However, in this case, John walks right by his cubicle to the cafeteria to get a cup of coffee. Based on acceleration data detected by an accelerometer of John's smartphone, the connection manager determines that while John is close to the wireless dock, he is still moving, and thus a connection to the wireless dock is not established at this time.

Next, John walks from the cafeteria to his cubicle to stand by his monitor. In this case, the connection manager determines that John's mobile phone is within close proximity (e.g., less than 1 meter) to the wireless dock based on both the signal strength of the BTLE beacon transmitted from the wireless dock and the accelerometer data which indicates that John is no longer moving. Thus, the connection manager initiates a first user experience in which the mobile computing device causes the monitor attached to the wireless dock to display a “Welcome John” message, and may also display other information for John to glance at, such as upcoming calendar appointments, text messages, social media notifications, and so forth. If John is not yet ready to start work, he can simply leave his cubicle and the welcome message will disappear after a predetermined period of time.

Alternately, if John is ready to start working, he may simply interact with peripheral devices attached to the wireless dock. So, for example, John can simply move a mouse attached to the wireless dock or press a key on a keyboard. This user action triggers the connection manager to initiate a second user experience, such as by causing display of a home screen or lock screen on the monitor which allows John to start working.

### Example Environment

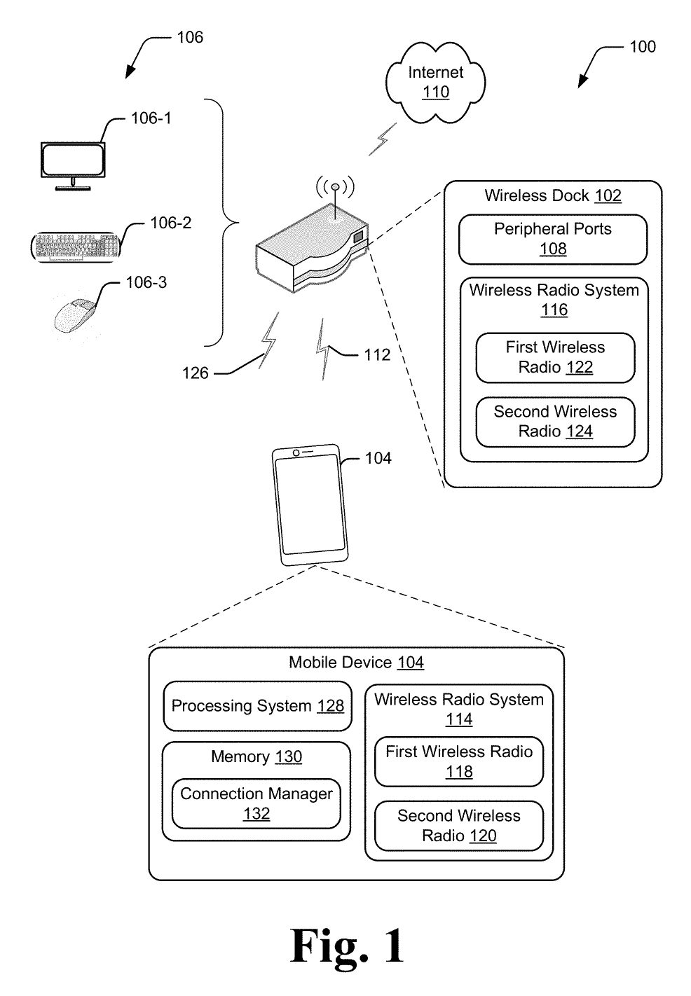

FIG. 1 is an illustration of an environment 100 in an example implementation that is operable to employ techniques for managing automatic connections to a wireless dock. The illustrated environment 100 includes a wireless dock 102 and a mobile computing device 104 which can wirelessly connect to wireless dock 102 to utilize various peripheral devices 106 attached to wireless dock 102. Wireless dock 102 may be implemented as a separate device, or implemented within a computing device, such as a personal computer. Thus, the term wireless dock is meant to refer to either a standalone device that enables wireless docking, or functionality and hardware inside of a device (e.g., a personal computer) that enables wireless docking.

Mobile computing device 104 can be a variety of different types of devices, and typically is a mobile computing device such as a cellular or other wireless phone (e.g., a smartphone), a tablet or phablet device, a notepad computer, a laptop or netbook computer, a wearable device (e.g., eyeglasses, watch), and so forth. Alternatively, the mobile computing device 104 can be other types of devices that are not typically considered to be mobile computing devices, such as an entertainment device (e.g., an entertainment appliance, a set-top box communicatively coupled to a display device, a game console), a desktop computer, a server computer, a television, and so forth.

Wireless dock 102 includes peripheral ports 108 which enable peripheral devices 106 to connect to wireless dock 102. In this example, peripheral devices 106 includes a display device 106-1, a keyboard 106-2, and a mouse 106-3. However, a variety of other peripheral devices may also connect to wireless dock 102 via peripheral ports 108, such as cameras, printers, speakers, storage media, keypads, other cursor control devices, and so forth. Peripheral ports 108 may also enable wireless dock 102 to be connected to the Internet 110, such as via a Wi-Fi radio or an Ethernet connection.

In various implementations, mobile computing device 104 can form a wireless connection 112 with wireless dock 102 to enable the transfer of data and information between mobile computing device 104 and wireless dock 102. In some cases, the wireless connection 112 enables the mobile computing device 104 to provide a separate user experience on the display device 106-1. For example, once wirelessly connected to the wireless dock 102, rather than simply seeing a larger version of what is displayed on the mobile computing device 104, the mobile computing device 104 powers a separate user experience that allows for productivity and other experiences. To do so, mobile computing device 104 may include at least two separate software stacks, one which controls the user experience on the mobile computing device 104, and a second which controls the user experiences on display device 106-1 when connected via wireless dock 102. Thus, in some cases, the information displayed on display device 106 is different than the information displayed on an integrated display of mobile computing device 104. This allows the user to use the different display devices independently. For example, the mobile computing device 104 may display a home screen on the display device 106-1 which enables the user to perform various productivity-related tasks, and concurrently display a different home screen on the integrated display of mobile computing device 104 to allow the user to use the mobile computing device 104 as a telephone.

In order to enable the wireless connection, mobile computing device 104 includes a wireless radio system 114 which is configured to interface with a wireless radio system 116 of wireless dock 102 in order to establish the wireless connection 112 with wireless dock 1022.

Wireless radio systems 114 and 116 each include at least one wireless radio, which may include any type of short-range wireless radio system, such as wireless USB radio system, a Bluetooth™ radio system, WiGig (802.11ad), Wi-Fi Direct, and so forth. Wireless radio systems 114 and 116 can include a radio device, antenna, and chipset that is implemented for a particular wireless communications technology.

In one or more implementations, wireless radio system 114 of mobile computing device 104 includes a first wireless radio 118 and a second wireless radio 120 which are configured to interface with a first wireless radio 122 and a second wireless radio 124, respectively, of the wireless radio system 116 of wireless dock 102.

In one or more implementations, the first wireless radio 118 of mobile computing device 104 is utilized by mobile computing device 104 to determine that it is within close proximity to the wireless dock 102 by detecting a beacon signal 126 transmitted by the first wireless radio 122 of wireless dock 102. The second wireless radio 120 of mobile computing device 104 is configured to interface with the second wireless radio 124 of wireless dock 102 in order to establish the wireless connection 112. Once established, the wireless connection 112 enables sending output to display 106-1, and receiving input from keyboard 106-2, mouse 106-3, as well as other peripherals connected to wireless dock 102.

In one or more implementations, wireless radio system 114 of mobile computing device 104 may include only a single wireless radio 118 which is configured to interface with a single wireless radio 122 in wireless dock 102. In this configuration the role of the first wireless radio and the second wireless radio are fulfilled by the same wireless radio. Notably, this configuration may be implemented in cases where a single wireless radio is capable of providing both a beaconing or proximity capability and sufficient capability for handling a docking connection, a wireless connection capable of supporting at a minimum output to display 106-1, and input from peripheral devices such as devices 106-2 and 106-3. For example, some wireless radios, such as WiGig (802.11ad) or Wi-Fi Direct, are capable of producing a beacon and also carry sufficient bandwidth to meet the needs of the docking scenarios discussed herein.

In various implementations, first wireless radios 118 and 122 are wireless personal area network (WPAN) radios which are compliant with various WPAN standards, such as Bluetooth™ standards, IEEE 802.15 standards, infrared data association (IrDA) standards, or wireless USB standards, to name just a few. For example, first wireless radios 118 and 122 may be implemented as Bluetooth Low Energy (BTLE) radios. In BTLE, when two devices are configured for proximity behaviors, one device becomes the beacon and the other device is the listener. Once the listener detects the presence of the beacon the devices are assumed to be in range of each other, which typically occurs at 100 meters or less. Thus, in this implementations, first wireless radio 118 of mobile computing device 104 can be configured as the “listener” in order to detect a BTLE beacon signal 126 transmitted by first wireless radio 122, which is configured as the beacon, of wireless dock 102.

In various implementations, second wireless radios 120 and 124 are wireless local area network (WLAN) radios which are compliant with any of the various IEEE 802.11 (also referred to as WiFi™) standards, WiFi Direct, Miracast, wireless-wide-area-network (WWAN) radios for cellular telephony, wireless-metropolitan-area-network (WMAN) radios compliant with various IEEE 802.16 (also referred to as WiMAX™) standards, and wired local-area-network (LAN) Ethernet transceivers, and so forth.

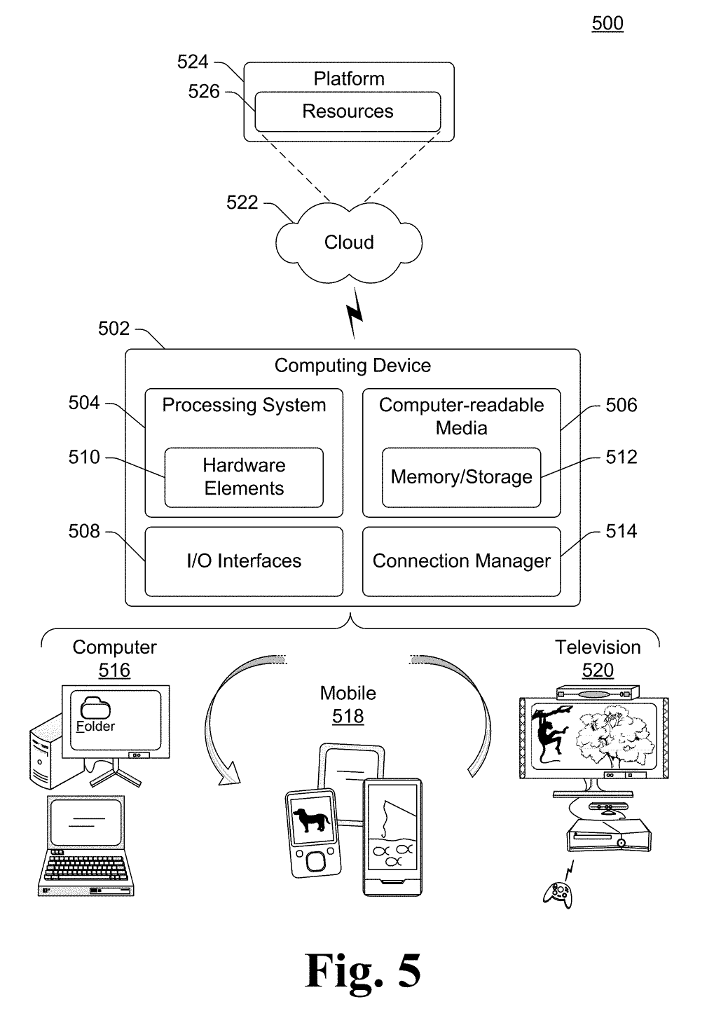

Mobile computing device 104 can also be implemented with various components, such as a processing system 128, a memory 130, and with any number and combination of different components as further described with reference to the example device shown in FIG. 5.

Mobile computing device 104 also includes a connection manager 132 that can be implemented as a software application or module, such as executable software instructions (e.g., computer-executable instructions) that are executable with processing system 128 of the mobile computing device to implement embodiments of managing automatic connections to a wireless dock. Connection manager 132 can be stored on computer-readable storage memory (e.g., memory 130), such as any suitable memory device or electronic data storage implemented by the mobile computing device. In implementations, connection manager 132 is a component of the device operating system, or can be implemented as part of a wireless connection service on the mobile computing device.

Connection manger 124 enables the mobile computing device 104 to establish an initial wireless connection 112 to wireless dock 102 via the wireless radio system 114 (e.g., between second wireless radios 120 and 124). After the initial wireless connection 112 is established, the connection manager 132 enables the user to configure the mobile computing device 104 to “auto reconnect”, such that the mobile computing device 104 can automatically re-establish the wireless connection 112 if the mobile computing device 104 is within a close proximity to the wireless dock 102 (e.g., within 1 meter). Consider now a detailed discussion of how connection manager 124 manages the automatic wireless connection 112 to the wireless dock 102.

In one or more implementations, connection manager 132 configures the first wireless radio 118 to begin listening for beacon signals 126 from the first wireless radio 122 of wireless dock 102 only after it is established that the mobile computing device 104 is within a general proximity to the wireless dock 102. Doing so causes the first wireless radio 118 to only begin scanning for the beacon signal 126 when there is a high likelihood of actually detecting the beacon signal.

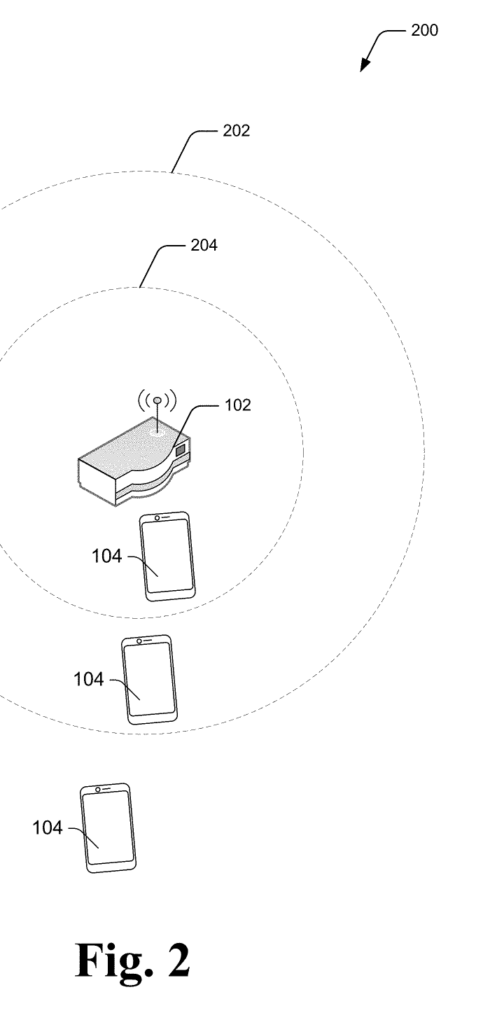

As an example, consider FIG. 2, which illustrates an example 200 of using a general proximity boundary and a close proximity boundary to manage automatic wireless connections to a wireless dock.

In example 200, connection manager 132 determines a general proximity 202 around a wireless dock 102 corresponding to a boundary of a particular range. For example, the general proximity 202 may be set up at a user's office building or home, such that the connection manager can determine that the mobile computing device 104 is within the general proximity 202 when the user enters their office building or home.

Connection manager 132 can configure the boundary of general proximity 202 in a variety of different ways. In one or more implementations, connection manager 132 uses “geo-fencing” to generate the boundary of general proximity 202. For example, a geo-fence with a reasonably large radius (e.g., 150 meters) may be established around a position of the wireless dock 102. The connection manager 132 can then utilize positioning data, such as from a sensor (e.g., a GPS sensor) of the mobile computing device 104, to determine when the mobile computing device 104 is within the geo-fence.

Alternately or additionally, connection manager 132 can leverage alternate radios to generate boundary of general proximity 202. For example, a Wi-Fi radio of mobile computing device 104 can be configured to scan for a particular SSID or unique Wi-Fi Access Point address that is within the general proximity 202. In this case, the SSID may be associated with the wireless dock 102 or with a particular location, such as the Wi-Fi network of the user's home or office. Thus, detection of the SSID indicates to connection manager 132 that mobile computing device 104 is within the general proximity 202 to wireless dock 102.

After it is determined that the mobile computing device 104 has moved within the general proximity 202, the connection manager causes the first wireless radio 118 to begin listening or scanning for the beacon signal 126 transmitted from first wireless radio 122 of wireless dock 102. For example, when implemented as a BTLE radio, connection manager 132 may register the BTLE radio with a listener slot of the mobile computing device 104. Notably, therefore, this functionality is hardware offloaded and would allow for registration of a BTLE listener only when the connection manager 132 is reasonably sure that the wireless dock 102 is likely to be discovered.

Similarly, connection manager 132 can determine when the mobile computing device 104 moves outside the general proximity 202, and then cause the first wireless radio 118 to stop listening for the beacon signal 126 associated with the wireless dock 102. For example, in response to detecting that mobile computing device 104 have moved outside the geo-fence or the range of the Wi-Fi SSID or Wi-Fi access point, connection manager 132 can remove the BTLE listener associated with wireless dock 102 from the listener slot, which frees up the listener slot for use by other applications. This guarantees that only when there is a high likelihood of actually connecting to the device is the listener slot actively used.

While mobile computing device 104 is within general proximity 202 to wireless dock 102, connection manager 132 monitors first wireless radio 118 to determine whether the mobile computing device 104 is within a close proximity 204 to the wireless dock 102. Notably, the range of close proximity 204 is less than the range of general proximity 202. For example, the general proximity 202 may have a radius of 100 to 200 meters from the wireless dock 102, whereas the close proximity 204 may have a radius of just 1 to 3 meters.

Connection manager 132 can determine that the mobile computing device is within the close proximity 204 to the wireless dock 102 based on the first radio 118 detecting the beacon signal 126 transmitted by first wireless radio 122 of wireless dock 102. In some cases, however, the first radio 118 may be able to detect the beacon signal 126 when the mobile computing device 104 is still outside of the close proximity 204. For example, a BTLE radio may be able to detect a BTLE beacon signal when it is 50 or 100 meters from the wireless dock 102.

Thus, in one or more implementations, connection manager 132 determines whether mobile computing device 104 is within the close proximity 204 to wireless dock 102 based on a signal strength of the beacon signal 126 detected by the first wireless radio 118. For example, after initially detecting the beacon signal 126, connection manager 132 can begin analyzing the beacon signal to determine its signal strength. Based on the signal strength, the connection manager 132 can determine an approximate distance of mobile computing device 104 from the wireless dock 102. For example, the stronger the signal, the closer the mobile computing device 104 is to the wireless dock 102. While generally reliable this method is not flawless. For example, placing all or part of a human body in between first wireless radios 118 and 122, or even placing the mobile computing device 104 in the user's pocket, may significantly impact the signal strength of the beacon signal 126, which may cause a false positive to occur.

Accordingly, in one or more implementations, connection manager 132 utilizes other sensor data, in conjunction with the signal strength of beacon signal 126, to determine whether mobile computing device 104 is within the close proximity 204 to wireless dock 102. For example, mobile computing device 104 may be equipped with an accelerometer (or any other type of motion sensor) which enables connection manager 132 to determine whether mobile computing device 104 is moving based on accelerometer data detected by an accelerometer of the mobile computing device that indicates that movement of the mobile computing device is below a certain threshold.

Thus, if the signal strength of beacon signal 126 indicates that mobile computing device 104 is within the close proximity 204 to wireless dock 102, and the accelerometer data is below the certain threshold indicating that the mobile computing device 104 has stopped moving (or is slowing down), then connection manager 132 can determine that the user is likely sitting or standing near the wireless dock 102. In this case, connection manager 132 determines that mobile computing device 104 is within the close proximity 204 to wireless dock 102.

Alternately, if the signal strength of beacon signal 126 indicates that mobile computing device 104 is within the close proximity 204 to wireless dock 102, but the accelerometer data indicates that mobile computing device 104 is moving, then connection manager 132 can determine that the user is likely walking or running past the wireless dock 102. In this case, connection manager 132 determines that mobile computing device 104 is not within the close proximity 204 to wireless dock 102.

In response to determining that the mobile computing device 104 is within close proximity 204 to the wireless dock 102, connection manager 132 initiates a first user experience with wireless dock 102. The first user experience can be implemented in a variety of different ways, but generally includes the display of information in a first user interface on a display device connected to the wireless dock 102. For example, connection manager 132 may cause the display of a welcome screen on display device 106-1, coupled to wireless dock 102, in response to determining that mobile computing device 104 is within the close proximity 204 to wireless dock 102. This welcome screen may simply greet the user, or display information that the user may wish to be able to glance at, such as calendar events, notifications (e.g., text messages, email messages, social media notifications), and so forth.

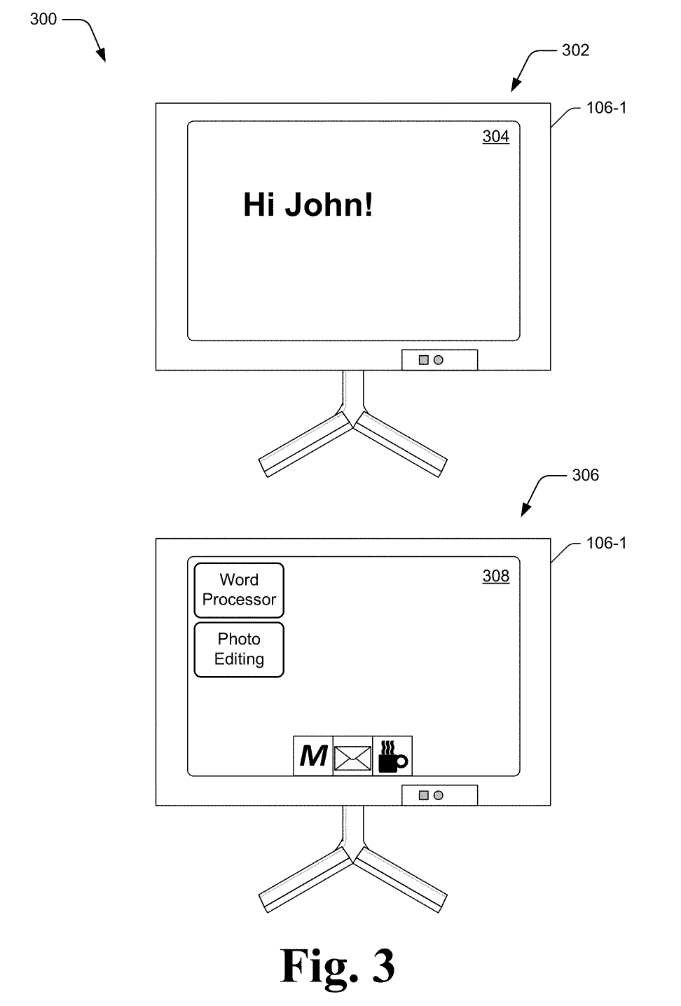

As an example, consider FIG. 3 which illustrates an example 300 of initiating first and second user experiences in accordance with one or more implementations. At 302, when mobile computing device 104 comes within the close proximity 204 to wireless dock 102, connection manager 132 initiates a first user experience by causing display device 106-1, which is coupled to wireless dock 102, to display a first user interface 304. In this case, first user interface 304 displays a welcome message that greets the user, who in this example is named John. Of course, it is to be noted that the first user interface 304 may include various different types of information, such as a user's calendar, notifications (e.g., text messages, emails, social media updates), and so forth.

In one or more implementations, connection manager 132 initiates the first user experience by forming the wireless connection 112 (e.g., Miracast over Wi-Fi) to the wireless dock 102 using the second wireless radio 120. In this case, connection manager 132 communicates display information associated with the first user interface (e.g., the welcome message) over the wireless connection 112 to wireless dock 102 using the second wireless radio 120.

Alternately, connection manager 132 can be configured to initiate the first user experience without forming the wireless connection 112 to wireless dock 102 using the second wireless radio 120. In this case, connection manager 132 initiates the first user experience by communicating a control signal or instructions to the wireless dock 132 effective to cause the wireless dock to display the first user interface 304. In this case, the mobile computing device does not need to communicate display information. Instead, the wireless dock 102 includes memory storing the display information (e.g., the welcome message) and a processor to cause the display information to be rendered in the first user interface 304. Notably, in this implementation the battery life of mobile computing device 104 is conserved because the wireless connection 112 is not automatically established each time that mobile computing device 102 comes with the close proximity to wireless dock 102.

After the first user experience is initiated, connection manager 132 monitors for a user action that indicates user intent to form a more active wireless connection 112 to wireless dock 102. A variety of different user actions can be detected which indicate user intent, such as user interaction with one or more peripheral devices 106 coupled to wireless dock 102. For example, the user action could include interacting with a touchscreen of display device 106-1, typing on keys of keyboard 106-2, or moving mouse 106-3, and so forth. In cases where the wireless connection 112 is formed as part of the first user experience, the connection manager 132 can detect the user action based on signals communicated from the wireless dock 102 to the mobile computing device 104 over the wireless connection 112 using the second wireless radio 120. Alternately, in cases where the wireless connection 112 is not formed as part of the first user experience, the connection manager 132 can detect the user action based on signals communicated from the wireless dock 102 using the first wireless radio 118 (e.g., a BTLE signal).

If the user action indicative of intent is not detected within a certain pre-determined or user-configured period of time (e.g., 30, 60, or 90 seconds), then connection manager 132 may determine that the user does not wish to interact with the wireless dock 102, and thus removes the first user interface 304 from the display device 106-1 and the mobile computing device 104 may go back into a standby or low power mode.

Alternately, if the user action is detected within the certain period of time (e.g., by the user interacting with a mouse and keyboard coupled to the wireless dock), then the connection manager 132 initiates a second user experience by causing display of a second user interface on the display device coupled to the wireless dock. In cases where the wireless connection 112 is formed as part of the first user experience, connection manager 132 initiates the second user experience by communicating with wireless dock 102 using the wireless connection 112. Alternately, in cases where the wireless connection 112 is not formed as part of the first user experience, connection manager 132 initiates the second user experience by first establishing the wireless connection 112 with the wireless dock 102 using the second wireless radio 120, and then communicating with wireless dock 102 using the wireless connection 112. Notably, the information displayed in the second user interface is different than the information displayed in first user interface. Thus, the system recognizes that the user action indicates that the user has sat down or intends to interact with the system, and thus a next level of information is displayed to the user.

For example, at 306, in response to detection of the user action, connection manager 132 initiates a second user experience by using second wireless radio 120 to communicate information or control signals over the wireless connection 112 to wireless dock 102. The information or control signals are effective to cause display device 106-1, which is coupled to wireless dock 102, to display a second user interface 308. In this example, the second user interface 308 corresponds to a “home screen”. As described herein, a home screen, also referred to as a start screen, is the displayed screen from which the user can request to run various different programs of the mobile computing device 104. In one or more embodiments, the home screen is the first screen with user-selectable representations of functionality displayed after the user logs into (or turns on or wakes up) the mobile computing device 104. Various different user-selectable representations of functionality can be included on a home screen, such as tiles, icons, widgets, menus, menu items, and so forth, and these different representations can be selected via any of a variety of different user inputs. The functionality refers to different functions or operations that can be performed by the mobile computing device 104, such as running one or more applications or programs, displaying or otherwise presenting particular content, and so forth. In one or more embodiments, the entirety of the home screen is displayed at the same time. Alternatively, different portions (also referred to as pages) of the home screen can be displayed at different times, and the user can navigate to these different portions using any of a variety of user inputs (e.g., left and right arrows, gestures such as swiping to the left or right, and so forth). Alternately, the second user interface 308 may correspond to a “lock screen”, which requires the user to enter authentication credentials before access to the home screen is granted.

It is appreciated that in an effort to save energy, mobile device 104 may be configured to time out and stop communication with wireless dock 102. For example, mobile device 104 may be configured to stop presenting content on display device 106-1 via wireless dock 102 after a period of time (e.g, a period of 30, 60, 90 seconds) in which input has not been received from keyboard 106-2 and/or mouse 106-3 connected to wireless dock 102. Under such circumstances connection manager 132 may be configured to ignore beacon events and avoid re-creating a wireless connection 112 or 126 between mobile device 104 and wireless dock 102 to preserve this low power mode. In such circumstances detection of other events, such as leaving close proximity 204, or alternate beacons transmitted via first wireless radio 122 may cause connection manager 132 to wake up mobile device 104 and re-establish a connection between mobile device 104 and wireless dock 102.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

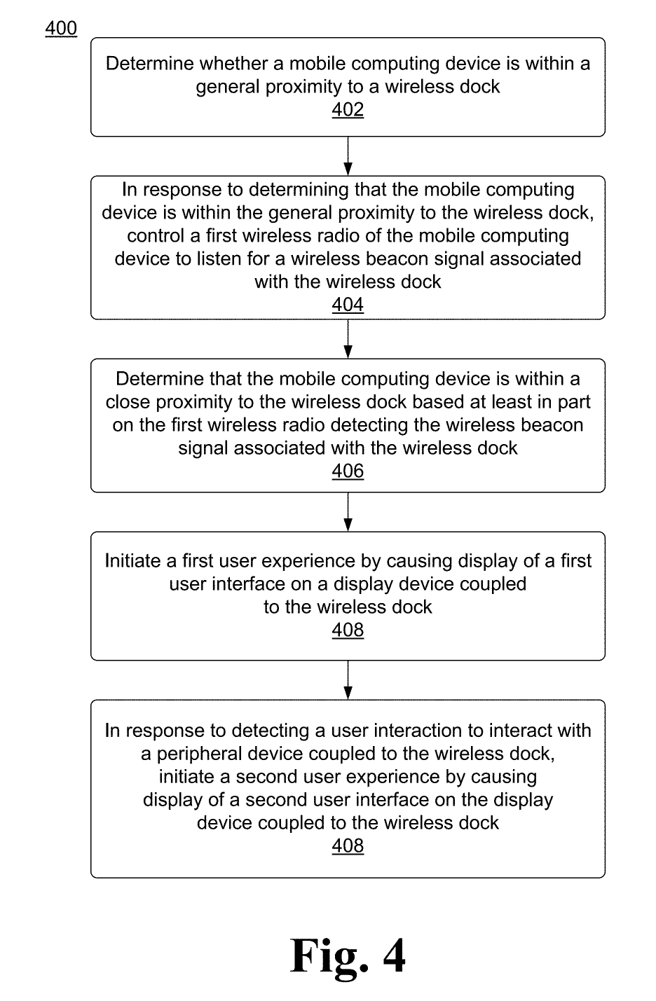

FIG. 4 depicts a procedure 400 in an example implementation of managing automatic connections to a wireless dock.

At 402, it is determined, at a mobile computing device, whether the mobile computing device is within a general proximity to a wireless dock. For example, connection manager 132 determines whether mobile computing device 104 is within a general proximity 202 to a wireless dock 102.

At 404, in response to determining that the mobile computing device is within the general proximity to the wireless dock, a first wireless radio of the mobile computing device is controlled to listen for a beacon signal associated with the wireless dock. For example, in response to determining that the mobile computing device 104 is within the general proximity 202 to the wireless dock 102, connection manager 132 controls first wireless radio 118 of the mobile computing device 104 to listen for a beacon signal 126 associated with the wireless dock 102.

At 406, it is determined that the mobile computing device is within a close proximity to the wireless dock based at least in part on the first wireless radio detecting the beacon signal associated with the wireless dock. For example, connection manager 132 determines that the mobile computing device 104 is within close proximity 204 to the wireless dock 102 based at least in part on the first wireless radio 118 detecting the beacon signal 126 associated with the wireless dock 102.

At 408, in response to determining that the mobile computing device is within the close proximity to the wireless dock, a first user experience is initiated by causing display of a first user interface on a display device coupled to the wireless dock. For example, in response to determining that the mobile computing device 104 is within the close proximity 204 to the wireless dock 102, connection manager 132 initiates a first user experience by causing display of a first user interface 304 on a display device 106-1 coupled to the wireless dock 102.

In one or more implementations, connection manager 132 initiates the first user experience by forming the wireless connection 112 (e.g., Miracast over Wi-Fi) to the wireless dock 102 using the second wireless radio 120. In this case, connection manager 132 communicates display information associated with the first user interface (e.g., the welcome message) over the wireless connection 112 to wireless dock 102 using the second wireless radio 120.

Alternately, connection manager 132 can be configured to initiate the first user experience without forming the wireless connection 112 to wireless dock 102 using the second wireless radio 120. In this case, connection manager 132 initiates the first user experience by communicating a control signal or instructions to the wireless dock 132 effective to cause the wireless dock to display the first user interface 304. effective to cause the wireless dock to display the first user interface.

At 410, in response to detecting a user action to interact with a peripheral device coupled to the wireless dock, a second user experience is initiated using a second wireless radio and causing display of a second user interface on the display device coupled to the wireless dock. For example, in response to detecting a user interaction to interact with a peripheral device 106 coupled to the wireless dock 102, connection manager 132 initiates a second user experience by causing display of a second user interface 308 on the display device 106-1 coupled to the wireless dock 102.

In cases where the wireless connection 112 is formed as part of the first user experience, the connection manager 132 can detect the user action based on signals communicated from the wireless dock 102 to the mobile computing device 104 over the wireless connection 112 using the second wireless radio 120. Alternately, in cases where the wireless connection 112 is not formed as part of the first user experience, the connection manager 132 can detect the user action based on signals communicated from the wireless dock 102 using the first wireless radio 118 (e.g., a BTLE signal).

In cases where the wireless connection 112 is formed as part of the first user experience, connection manager 132 initiates the second user experience by communicating with wireless dock 102 using the wireless connection 112. Alternately, in cases where the wireless connection 112 is not formed as part of the first user experience, connection manager 132 initiates the second user experience by first establishing the wireless connection 112 with the wireless dock 102 using the second wireless radio 120, and then communicating with wireless dock 102 using the wireless connection 112.

### Example System and Device

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes a connection manager 514. The connection manager 514 provides various functionality supporting managing automatic connections to a wireless dock as discussed above. For example, the connection manager 514 can be implemented as connection manager 132 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile computing device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile computing devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

### Conclusion and Example Implementations

Example implementations described herein include, but are not limited to, one or any combinations of one or more of the following examples:

A mobile computing device comprising: a first wireless radio configured to listen for a beacon signal associated with a wireless dock; a second wireless radio configured to form a wireless connection to the wireless dock; and a connection manager implemented at least partially in hardware, the connection manager configured to: initiate a first user experience by causing display of a first user interface on a display device coupled to the wireless dock in response to determining that the mobile computing device is within a close proximity to the wireless dock based at least in part on the first wireless radio detecting the beacon signal associated with the wireless dock; and initiate a second user experience by causing display of a second user interface on the display device coupled to the wireless dock in response to detecting a user action to interact with a peripheral device coupled to the wireless dock.

A mobile computing device as described above, wherein the connection manager is further configured to cause the first wireless radio to begin listening for the beacon signal associated with the wireless dock when the mobile computing device moves within a general proximity to the wireless dock, and to cause the first wireless radio to stop listening for the beacon signal associated with the wireless dock when the mobile computing devices moves outside the general proximity to the wireless dock.

A mobile computing device as described above, wherein a range of the close proximity is less than the range of the general proximity.

A mobile computing device as described above, wherein the first wireless radio comprises a Bluetooth Low Energy (BTLE) wireless radio, and wherein the connection manager causes the BTLE wireless radio to begin listening for the beacon signal by registering the BTLE radio in a listener slot, and causes the BTLE wireless radio to stop listening for the beacon signal by removing the BTLE wireless radio from the listener slot.

A mobile computing device as described above, wherein the connection manager is configured to determine whether or not the mobile computing device is within the general proximity by: configuring a geo-fence around a position of the wireless dock; and determining, based on positioning data received from a sensor of the mobile computing device, whether the mobile computing device is within the geo-fence.

A mobile computing device as described above, wherein the connection manager initiates the first user experience by forming the wireless connection to the wireless dock using the second wireless radio and using the wireless connection to initiate the first user experience.

A mobile computing device as described above, wherein the first user experience is initiated without forming the wireless connection to the wireless dock using the second wireless radio, and wherein the connection manager initiates the first user experience by communicating a control signal or instructions to the wireless dock using the first wireless radio, the control signal or instructions effective to cause the wireless dock to display the first user interface.

A mobile computing device as described above, wherein the second user experience further comprises forming the wireless connection to the wireless dock using the second wireless radio.

A mobile computing device as described above, wherein the connection manager determines that the mobile computing device is within the close proximity based at least in part on a signal strength of the beacon signal detected by the first wireless radio.

A mobile computing device as described above, wherein the connection manager initiates the first user experience in response to determining that the mobile computing device is within the close proximity to the wireless dock and based on accelerometer data detected by an accelerometer of the mobile computing device that indicates that movement of the mobile computing device is below a certain threshold.

A computer-implemented method comprising: determining, at a mobile computing device, whether the mobile computing device is within a general proximity to a wireless dock; in response to determining that the mobile computing device is within the general proximity to the wireless dock, controlling a first wireless radio of the mobile computing device to listen for a beacon signal associated with the wireless dock; determining that the mobile computing device is within a close proximity to the wireless dock based at least in part on the first wireless radio detecting the beacon signal associated with the wireless dock; in response to determining that the mobile computing device is within the close proximity to the wireless dock, initiating a first user experience by causing display of a first user interface on a display device coupled to the wireless dock; and in response to detecting a user interaction to interact with a peripheral device coupled to the wireless dock, initiating a second user experience by causing display of a second user interface on the display device coupled to the wireless dock.

A computer-implemented method as described above, wherein the determining that the mobile computing device is within the general proximity of the wireless dock further comprises configuring a geo-fence around a position of the wireless dock, and determining, based on positioning data received from a sensor of the mobile computing device, that the mobile computing device is within the geo-fence.

A computer-implemented method as described above, wherein the first wireless radio comprises a Bluetooth Low Energy (BTLE) radio, and wherein the controlling the first wireless radio to listen for the beacon signal comprises registering the BTLE radio in a listener slot.

A computer-implemented method as described above, further comprising removing the BTLE radio from the listener slot in response to determining that the mobile computing device has moved outside the general proximity to the wireless dock.

A computer-implemented method as described above, wherein the determining that the mobile computing device is within the close proximity is further based on a signal strength of the beacon signal detected by the first wireless radio.

A computer-implemented method as described above, wherein the determining that the mobile computing device is within the close proximity to the wireless dock is further based on accelerometer data detected by an accelerometer of the mobile computing device that indicates that movement of the mobile computing device is below a certain threshold.

A computer-implemented method as described above, wherein initiating the first user experience further comprises forming the wireless connection to the wireless dock using the second wireless radio and using the wireless connection to initiate the first user experience.

A computer-implemented method as described above, wherein the first user experience is initiated without forming the wireless connection to the wireless dock using the second wireless radio, and wherein initiating the first user experience further comprises communicating a control signal or instructions to the wireless dock using the first wireless radio, the control signal or instructions effective to cause the wireless dock to display the first user interface.

A computer-implemented method as described above, wherein initiating the second user experience further comprises forming the wireless connection to the wireless dock using the second wireless radio.

A mobile computing device comprising: a Bluetooth Low Energy (BTLE) radio configured to listen for a BTLE beacon signal associated with a wireless dock; a Wi-Fi radio configured to form a wireless connection to the wireless dock; and a connection manager implemented at least partially in hardware, the connection manager configured to: determine that the mobile computing device is within a geo-fence established around the wireless dock; in response to determining that the mobile computing device is within the geo-fence, register the BTLE radio with a listener slot to listen for the BTLE beacon signal associated with the wireless dock; in response to determining that the mobile computing device is within a close proximity to the wireless dock based on a signal strength of the BTLE beacon signal detected by the BTLE radio, initiate a first user experience by forming the wireless connection with the wireless dock using the Wi-Fi radio and causing display of a first user interface on a display device coupled to the wireless dock; and in response to detecting a user action to interact with a peripheral device coupled to the wireless dock, initiate a second user experience by causing display of a second user interface on the display device coupled to the wireless dock.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A mobile computing device comprising:
a first wireless radio configured to listen for a beacon signal associated with a wireless dock;
a second wireless radio configured to form a wireless connection to the wireless dock; and
a connection manager implemented at least partially in hardware, the connection manager configured to:
initiate a first user experience by causing display of a first user interface on a display device coupled to the wireless dock in response to determining that the mobile computing device is within a close proximity to the wireless dock based at least in part on the first wireless radio detecting the beacon signal associated with the wireless dock; and
initiate a second user experience by causing display of a second user interface on the display device coupled to the wireless dock in response to detecting a user action to interact with a peripheral device coupled to the wireless dock.

2. The mobile computing device of claim 1, wherein the connection manager is further configured to cause the first wireless radio to begin listening for the beacon signal associated with the wireless dock when the mobile computing device moves within a general proximity to the wireless dock, and to cause the first wireless radio to stop listening for the beacon signal associated with the wireless dock when the mobile computing devices moves outside the general proximity to the wireless dock.

3. The mobile computing device of claim 2, wherein a range of the close proximity is less than the range of the general proximity.

4. The mobile computing device of claim 2, wherein the first wireless radio comprises a Bluetooth Low Energy (BTLE) wireless radio, and wherein the connection manager causes the BTLE wireless radio to begin listening for the beacon signal by registering the BTLE radio in a listener slot, and causes the BTLE wireless radio to stop listening for the beacon signal by removing the BTLE wireless radio from the listener slot.

5. The mobile computing device of claim 2, wherein the connection manager is configured to determine whether or not the mobile computing device is within the general proximity by:
configuring a geo-fence around a position of the wireless dock; and
determining, based on positioning data received from a sensor of the mobile computing device, whether the mobile computing device is within the geo-fence.

6. The mobile computing device of claim 1, wherein the connection manager initiates the first user experience by forming the wireless connection to the wireless dock using the second wireless radio and using the wireless connection to initiate the first user experience.

7. The mobile computing device of claim 1, wherein the first user experience is initiated without forming the wireless connection to the wireless dock using the second wireless radio, and wherein the connection manager initiates the first user experience by communicating a control signal or instructions to the wireless dock using the first wireless radio, the control signal or instructions effective to cause the wireless dock to display the first user interface.

8. The mobile computing device of claim 7, wherein the second user experience further comprises forming the wireless connection to the wireless dock using the second wireless radio.

9. The mobile computing device of claim 1, wherein the connection manager determines that the mobile computing device is within the close proximity based at least in part on a signal strength of the beacon signal detected by the first wireless radio.

10. The mobile computing device of claim 1, wherein the connection manager initiates the first user experience in response to determining that the mobile computing device is within the close proximity to the wireless dock and based on accelerometer data detected by an accelerometer of the mobile computing device that indicates that movement of the mobile computing device is below a certain threshold.

11. A computer-implemented method comprising:
determining, at a mobile computing device, whether the mobile computing device is within a general proximity to a wireless dock;
in response to determining that the mobile computing device is within the general proximity to the wireless dock, controlling a first wireless radio of the mobile computing device to listen for a beacon signal associated with the wireless dock;
determining that the mobile computing device is within a close proximity to the wireless dock based at least in part on the first wireless radio detecting the beacon signal associated with the wireless dock;
in response to determining that the mobile computing device is within the close proximity to the wireless dock, initiating a first user experience by causing display of a first user interface on a display device coupled to the wireless dock; and
in response to detecting a user interaction to interact with a peripheral device coupled to the wireless dock, initiating a second user experience by causing display of a second user interface on the display device coupled to the wireless dock.

12. The computer-implemented method of claim 11, wherein the determining that the mobile computing device is within the general proximity of the wireless dock further comprises configuring a geo-fence around a position of the wireless dock, and determining, based on positioning data received from a sensor of the mobile computing device, that the mobile computing device is within the geo-fence.

13. The computer-implemented method of claim 11, wherein the first wireless radio comprises a Bluetooth Low Energy (BTLE) radio, and wherein the controlling the first wireless radio to listen for the beacon signal comprises registering the BTLE radio in a listener slot.

14. The computer implemented method of claim 13, further comprising removing the BTLE radio from the listener slot in response to determining that the mobile computing device has moved outside the general proximity to the wireless dock.

15. The computer implemented method of claim 11, wherein the determining that the mobile computing device is within the close proximity is further based on a signal strength of the beacon signal detected by the first wireless radio.

16. The computer implemented method of claim 11, wherein the determining that the mobile computing device is within the close proximity to the wireless dock is further based on accelerometer data detected by an accelerometer of the mobile computing device that indicates that movement of the mobile computing device is below a certain threshold.

17. The computer-implemented method of claim 11, wherein initiating the first user experience further comprises forming the wireless connection to the wireless dock using the second wireless radio and using the wireless connection to initiate the first user experience.

18. The computer-implemented method of claim 11, wherein the first user experience is initiated without forming the wireless connection to the wireless dock using the second wireless radio, and wherein initiating the first user experience further comprises communicating a control signal or instructions to the wireless dock using the first wireless radio, the control signal or instructions effective to cause the wireless dock to display the first user interface.

19. The computer-implemented method of claim 11, wherein initiating the second user experience further comprises forming the wireless connection to the wireless dock using the second wireless radio.

20. A mobile computing device comprising:
a Bluetooth Low Energy (BTLE) radio configured to listen for a BTLE beacon signal associated with a wireless dock;
a Wi-Fi radio configured to form a wireless connection to the wireless dock; and
a connection manager implemented at least partially in hardware, the connection manager configured to:
determine that the mobile computing device is within a geo-fence established around the wireless dock;
in response to determining that the mobile computing device is within the geo-fence, register the BTLE radio with a listener slot to listen for the BTLE beacon signal associated with the wireless dock;
in response to determining that the mobile computing device is within a close proximity to the wireless dock based on a signal strength of the BTLE beacon signal detected by the BTLE radio, initiate a first user experience by forming the wireless connection with the wireless dock using the Wi-Fi radio and causing display of a first user interface on a display device coupled to the wireless dock; and
in response to detecting a user action to interact with a peripheral device coupled to the wireless dock, initiate a second user experience by causing display of a second user interface on the display device coupled to the wireless dock.
